(19) United States
(12) Patent Application Publication
(10) Pub. No.: US 2011/0200792 A1
(43) Pub. Date: Aug. 18, 2011

(54) COATED SLIDE

(76) Inventors: Frederick Knute Husher, Pembroke Pines, FL (US); Jee Jong Shum, Miramar, FL (US)

(21) Appl. No.: 13/063,522

(22) PCT Filed: Sep. 11, 2009
(86) PCT No.: PCT/US09/56621

§ 371 Date: Mar. 11, 2011

Related U.S. Application Data
(60) Provisional application No. 61/191,950, filed on Sep. 12, 2008.

(51) Int. Cl. C09J 7/02; B32B 27/06; B32B 17/06; B32B 7/04; B32B 3/30

(52) U.S. Cl. 428/172; 428/447; 428/429; 428/355 R

(57) ABSTRACT

A single layer multi-silane coating construct displays controlled covalent attachment between biological materials and microscope slide substrates. Choice of various silanation reagents and their mix ratios provides control over the overall hydrophilic/hydrophobic surface behavior, attachment site density, and reactive moiety type. Both two-dimensional (2d) and three-dimensional (3d) configurations use the same foundation basics. Improved biological adhesion and fluid flow during subsequent processing is achieved. The 3d configuration offers conformal adhesion for those tissue materials that are not monotonically flat as well as multiple point capture of protein/peptides.

### TECHNICAL FIELD

The field of the invention is coated microscope slides.

### BACKGROUND ART

Gedig et al. (Pub. No. US 2005/0042455) is titled, “Coating for Various Types of Substrate and Method for the Production Thereof.” The substrate structure consists of a base glass, a silane coupler, and an adhesion promoting layer that lays entirely parallel to the silane substrate coupler. No structure that goes directly from the silane end to some point on a PAAH backbone is taught. An adhesion-mediating material is described. The adhesion-mediating material is described as a polyamine.

McGall et al. (Pub. No. US 2007/0275411) is titled, “Silane Mixtures.” This publication involves the use of mixed silanes for producing a controlled density of reactive sites that are initially capped and then uncapped to attach polymers thereto. No mention is made regarding controlling the hydrophilic/hydrophobic nature of the slide coating. The publication does not involve the attachment of polymer strands performed without first removing the protective caps.

Swan et al. (U.S. Pat. No. 7,300,756) is titled, “Epoxide Polymer Surfaces.” Swan et al. describes the construction and use of a reagent that is used to attach DNA strands to a glass microscope slide. The reagent attaches to the organo-silane coated glass by use of UV exposure. The DNA is then covalently bound to the free epoxide groups on the polymer.

Glass slides have been used to mount biological materials for the last century. For many years, the biological materials were affixed by simply ionic hydrogen bonds between the sample and a clean glass microscope slide. The glass, in its native clean state, has a slight negative charge due to the surface —OH terminal ends. The tissue/cells are overall more negatively charged; thus, they are naturally attracted to the more positive (i.e. less negatively charged) charge on the glass. Once dried, the ionic bond is established and the biological materials will remain reasonably affixed.

Later, it was discovered that egg-white albumin could be used to coat slides. Egg-white albumin provided for an actual adhesion with both ionic and covalent bonding. While protein coating would cross-link with applied protein and tissue, the adhesion between the protein coating and the applied biomaterials deteriorated when Heat Induced Epitope Retrieval (HIER) was applied and from background fluorescence of the protein coating itself. The fluorescence effect could be removed from the albumin before application onto a slide, but it was difficult to get the coating monotonically thin.

Other adhesives came into being including amino-silane and poly-1-lysine. These react with carboxyl sites on the biological materials, forming a nearly non-reversible covalent amide bond. However, with exposure to heat and high pH HIER buffers, pH>9, the amide bond can become hydrolyzed and reverse. Another common binding surface is an aldehyde-silane, which reacts with an amine on the biological material to form a Schiff base. The general solution is to apply an amino-silane surface and cross-link it with gluteraldehyde, resulting in an aldehyde-silane surface. Binding of the biomaterial amine sites to the aldehyde reactive moiety forms a Schiff base bond, which is reversible by the application of wet heat or low pH. Historically, nitrocellulose is attached to the glass surface by way of an amino-silane coating cross-linked with gluteraldehyde to form an aldehyde reactive end moiety. Newer techniques use a plasma treatment to apply an amine onto the glass without a silane structure, which is then cross-linked with gluteraldehyde. The free aldehyde then binds to an amine on poly-1-lysine polymer, which in turn binds to the nitrocellulose. Unfortunately, the Schiff base bonds will break with exposure to heat and water. Likewise, the formaldehyde fixation of tissue degenerates during the HIER process. Epoxide-silanes address all of these limitations, but bring some issues of their own. Epoxide moieties bind to amines on the biological material to form a non-reversible covalent bond. The epoxide binding does require the addition of heat to fully react, but the heat necessary is generally well within the normal drying cycle following the deposit of tissue and protein/peptide onto the slide. The other disadvantage to epoxide-silanes is the very hydrophobic nature of the epoxide moiety, which impacts the wetting behavior of the surface to cause water to be kept under the tissue because of capillary attraction.

All of the above biological adhesive structures are optimally constructed upon the glass slide as a high density mono-layer of a single type silane. While on first blush this would appear as the desirable path, it restricts the user to whatever behavioral constraints that material imposes upon the application of biological materials and subsequent reagent activities used in processing the sample. These limitations can include: adhesion strength, wettability during sample deposit, wettability in subsequent reagent activities, and binding capacity.

### DISCLOSURE OF INVENTION

It is accordingly an object of the invention to provide a coated slide that overcomes the above-mentioned disadvantages of the heretofore-known devices of this general type.

An object when making adhesive coated microscope slides is to have the highest density possible for the reactive binding coating. Such coatings provide amine, aldehyde, amide, carboxyl, epoxide, NHS-ester, and other organic reactive end groups, which for the most part use a silane base for coupling to the glass substrate. While these singular coatings can produce high adhesion densities, the reactive end points are generally hydrophobic, which will impact the movement of fluids during the initial biomaterial deposit and in the staining activities.

The invention uses a mixture of at least two components. The first component is a reactive silane. The second component can be a different reactive silane, a non-reactive silane, or a modifying hydrophilic top coating. Another term for top coat or top coating is overcoat. The hydrophilic top coating is not a silane. The top coat can be a hydrophilic polymer. The reactive silane is reactive to biomaterials. The non-reactive silane spacers can be neutral, hydrophilic, or hydrophobic in behavior with respect to water based applied fluids. The reactive spacer provides a taller vertical point than the surrounding silanes. Firstly, the reactive spacers function to break the surface tension of any applied fluid. Secondly, the reactive spacers provide additional binding sites. The reactive silanes can provide singular or multiple reaction moieties or be an anchor host to a polymer backbone, which is cross-linked to become reactive with biomaterials. The desired goal is to push the coated slide to being either dominantly hydrophobic or hydrophilic while providing for good fluid flow to avoid droplets or bubbles being formed. A temporary modifier can be applied to push an otherwise hydrophobic surface to appear as a hydrophilic surface to promote the deposit of tissue and uniformity of protein/peptide deposits.

The hydrophilic top coating is not applied as part of the silane mixture. They hydrophilic top coating must be applied in a separate application. The reactive and non-reactive silanes can be applied as a mixture or in separate steps. The silanes should be dried before the hydrophilic top coating is applied.

For the most part, the reactive silanes used to attach biological materials (protein/peptides, cells, and tissue) to slides react with a biomaterial's amine or carboxyl sites. While there are typically a great many amine sites on the biological materials, the density is much lower than the spacing between the silane molecules on the glass surface. However, if covalent bonds are formed, 100% binding density is not required to ensure the biomaterial is sufficiently anchored to the glass. Therefore, the opportunity exists wherein spacer silanes can be used to separate the reactive binding silanes and influence the overall hydrophilic/hydrophobic behavior of the surface. The spacer silanes are chosen such that they have a shorter terminal end spacer arm than the reactive silanes. The resulting mixture forms a 3-D structure on the slides, which contains isolated covalent binding sites surrounded by hydrophobic/hydrophilic spacers. The 3-D reactive structure depth can be enhanced by grafting a reactive polymer chain to the covalent binding silane sites. This increased depth provides a conformal binding mechanism that draws in tissue samples as it dries with continued binding attachment. More importantly for protein deposits, the polymer strand will tend to wrap itself around the protein, which greatly retards the protein's ability to uncoil if denaturing stimulus is applied. There is a limitation on the length of the polymer chain; if too long, the polymer chain will fall over and hinder the wettability provided by the hydrophilic spacers. Thus, the polymer strand length should be shorter than the spacing between the reactive silane binding sites.

Wettability & Porosity

The wettability behavior of coated slides is not a well understood phenomena. The wetting characteristic plays roles at several stages of tissue processing: initial application of tissue upon the slide, the staining of the biomaterial, and application of a cover slip. In terms of classic wetting tests, a known volume droplet of water is applied to a surface and the contact angle measured. The shallower the angle the more wettable the surface is. FIG. 8 illustrates the wetting behavior of water on a clean glass surface. This surface has a nearly monotonic surface chemistry of SiO₂. The surface can be temporarily modified by converting the surface chemistry to SiOH or SiOOH which would make the surface highly hydrophilic and the water would spread to a monolayer, assuming that no evaporation took place. However, that conversion is not stable nor desirable for covalent attachment of biomaterials or silane coatings.

When any type of adhesive coating is applied to the microscope slide surface, it introduces porosity to the surface. Generally, most all coatings are hydrophobic within the porosity, which forces most fluids to move about on the surface of the coating. The addition of surfactants or solvents can change that condition possibly allowing penetration within porous structure. Unless the porosity is large surfactants will have no effect as they are large molecules themselves. However, small solvent molecules such as alcohol or methanol can pass within the structure.

When the applied adhesive coating is composed of silanes with different spacer arm lengths, then porosity takes on a new meaning. Consider the case when the silane coating is all of the same spacer arm height. The applied biomaterial can only bind to the silane when the tissue supporting water can be discharged away. The degree of which the silane end group is hydrophilic or hydrophobic dominates how the water will be displaced to allow the biomaterial to fully bond with the coating. Now consider the case when the silane coating is composed of differing spacer arm lengths. Micro-sized channels can duct the water away allowing the tissue to settle down faster. If the shorter spacer arm silane is hydrophobic, the water will be forced to move away because of gravity and captured binding sites of the longer silane drawing the biomaterial down and applying pressure upon the liquid to move away. If the shorter spacer arm silane was hydrophilic, then the water would be trapped and the tissue may not become fully captured as the slide is dried. Drying of the non-bound side of the tissue will occur first causing the tissue to be hardened before it can settle down and be bound. Thus, capture voids will be formed, which can lead to loss of some or all of the tissue during subsequent sample processing.

Should both height silanes be reactive with the biomaterial, then as the water is discharged, the tissue will become additionally bound.

Generally, all biomaterial reactive moieties are hydrophobic, which can lead to the formation of micro-bubbles and initial skittish behavior of the tissue section on the slide. Micro-bubbles form on a hydrophobic surface because upon entrance of the slide into the bath, the liquid cannot fully displace the air trapped in the porous structure. Micro-bubbles remaining between the coating and the tissue section will usually form voids. These voids will rupture the tissue during the HIER process and can cause loss of tissue if not eliminated. It is desirable then to apply a temporary non-reactive hydrophilic topcoat to the slide. This surface treatment ensures that the slide will not support micro-bubble adhesion when initially placed into the sectioned tissue bath as well as promote fast draining of the water, which allows the tissue to settle down onto the slide surface before it can dry and be left with a lifted portion. An additional benefit of the surface treatment is that the reactive silane moieties are generally encapsulated and thus protected from unintended reactions with airborne contamination prior to the application of a tissue section. Such a material could be a short length hydrophilic polymer. The polymer is released into the sectioned tissue bath upon immersion, where it remains effectively inert to any tissue sections because of the very low concentration density. The application of such a hydrophilic material onto a hydrophobic surface would normally cause the hydrophilic material to be disassociated and rejected from the slide unless applied correctly.

For protein/peptide/enzyme deposits a different set of conditions arise. When these biomaterials are deposited, they are carried in a printing buffer slurry. The attributes of the buffer and the structure of the slide coating must work together to enable monotonic single layer deposits. Because the biomaterials are so small, the movement of the slurry is affected by the height modulation, porosity, Zeta potential of the biomaterials, and the viscosity, and pH of the buffer. If a single-silane coating is used, the biomaterials tend to be repelled by the coating to give the appearance that the coating is strongly hydrophobic. If another long spacer arm hydrophobic silane is added at a low concentration, it acts to stop the movement of the slurry from excessive spreading before capture can take place. This behavior is realized because there is sufficient obstruction of the slurry movement that the buffer is able to drop into the porosity and leave the biomaterial stranded above. Balance must be reached between the coating and the slurry such that this can occur. Very large deposits, one centimeter (1 cm) in diameter, are possible as a uniform and round single layer with very crisp edge detail.

Frozen tissue processing involves fast freezing of fresh tissue, thin sample cutting, and adhesion onto a slide while the sample is kept at −20° C. Because the tissue has not been fixed, the HIER processing step is bypassed and staining is then used to process the mounted and fixed sample. When the sample is fast frozen no ice crystals containing trapped air are formed in the tissue. Any trapped air in the frozen water would lead to destructive action on the tissue as the crystal increases in size. However, water is very much present in the tissue slice. To provide good adhesion to the coated slide, the coating must provide high wettability and photo-reactive covalent bonding. Because of the cold temperature, covalent bonding is slowed. To resolve this, flash UV can be directed from below the slide and will be sufficient to induce the covalent reaction by epoxide end groups before the fixation step. Once the slide/tissue is unfrozen, the additional heat will complete the covalent bonding.

Wettability can also be caused even though the surface is otherwise hydrophobic by the use of tall reactive silanes in a slightly lower concentration than the feature size of cells. This occurs because the tall silanes break the surface tension of the applied liquid carrying loose cells. Such an application would be used in capturing a mono-layer of loose cells as would occur in a blood smear, urine analysis, or PAP smear processing. In some applications, it is desirous to able to apply cells in slurry onto the slide. The cells are allowed to settle by the passage of time or are accelerated by centrifugal action. After a period of time, the excess liquid and unbound cells are washed off leaving a mono-layer of cells attached.

In the application of PAP smears, the automated preparation instruments separates the mucus from the cells. Two different processing methods are then used to transfer cells to the slide.
A. One method, used by Veracel Inc., adds water to the washed cell mass to bring the cell density to a consistent concentration within the volume by measuring the turbidity. A pipette then aspirates a fixed volume and deposits it within a hydrophobic barrier ring. The cells are allowed to settle and bind to the surface. The intent is to ensure that the aspirated content only contains enough cells to settle into a monolayer.
B. The other method simply uses a transfer contact method wherein the filter is pressed onto the slide. Those cells on the filter are then transferred to the slide surface. Excess cells not bonded to the slide surface are then washed off during the staining. Density of cells is simply controlled by the adhesive capacity of the slide. The diameter of the transferred cells is then set by the filter diameter. There is a question as to the efficacy of the filter approach in that cells initially trapped by the filter are not likely to be transferred to the slide and thus the cell sample is not reflective of the distribution of cells within the PAP sample.

Both forms require good wettability of the surface and adhesion that does not lose cells during the staining processing. The current slide substrates are not particularly good at cell retention because of chaotic binding ability. Both substrates require good hydrophilic behavior so that a monolayer of cells can be captured.

Another application is for a cyto-centrifuge. Typically a cyto-centrifuge forces cells floating within a liquid volume, such as urine, to one end of a sample tube. That end contains a removable plate that is withdrawn to transfer the concentrated solids & cells to a microscope slide. If however, the slide itself was used at the bottom, then only a gasket is needed to keep the fluid column in place. To ensure that the gasket does not cause damage to the coating or becomes contaminated, a ring of epoxy is printed for the gasket to press against. A monolayer of cells will become attached to the slide's covalent coating. All excess material is then simply washed away.

Silane Coupling Agents

Silane coupling agents are organo-silicone compounds having two functional groups with different reactivity. One of the functional groups reacts with organic materials while the other reacts with inorganic materials. The general structure is the following:

Y—R—Si—(X)₃

X denotes a functional group that undergoes hydrolysis by water or moisture to form silanol, which links with inorganic materials, such as glass or plastic. Examples of X include chlorine, alkoxy, and acetoxy groups. Y is a functional group that links with organic materials via a terminal end group of amine, epoxy, aldehyde, amide, NHS-ester, etc.

For attachment with glass substrates such as microscope slides the X functional groups include: CH₂O, CH₂CH₃O, and CH₃. These functional groups and their spacer aims impose the spacing between adjacent silane coupling agents. It is important that the saline deposit form only a mono-layer as multi-layer deposits corrupt the otherwise inherent hydrophilic/hydrophobic behavior of the coating. In general, surplus silane deposits will shift the coating behavior towards less hydrophobic and even to becoming quite noticeably hydrophilic simply because of the hydrophilic nature of the X function groups. Additionally, when the silane bonds to the glass, it releases the X functional groups. If the silane coating builds too quickly or grows beyond a mono-layer, then the X functional groups can become trapped in the silane coating and cause the coating to become more hydrophilic along with the possibility of becoming entangled in the fluid transportation channels.

Reactive binding functional groups are composed of a spacer arm and an end reactive moiety. The spacer links most significantly establish the height above the glass substrate that the reactive moiety is located. Depending upon the reactive moiety structure, the bond link to the organic can be ionic, reversibly covalent, or non-reversibly covalent. In the application of biomaterial tissue adhesion, the ionic and reversibly covalent bonds can be broken during heat induced epitope retrieval, HIER, resulting in partial or complete loss of the tissue from the substrate. With heat between 100 and 120° C. and high/low pH baths, the ionic bonds fail. Reversibly covalent bonds (such as the Schiff base aldehyde-amine reaction) will reverse when sufficient heat and water and/or low pH is presented to the bond. The HIER process at 100° C. is more than sufficient to challenge the Schiff base bond stability. Survivable HIER bonds are most cost effectively realized with epoxide-amine reactions, which remain completely stable through 120° C. exposure.

The preferred spacer arm length difference between the reactive-silane and spacer-silane is one or more carbon atoms with the optimal difference being two carbon atoms.

Hydrophilic spacers containing non-reactive functional groups that promote hydrophilic behavior include the following:

Non-Polarized End Groups
Amide (also called a peptide bond), which has a (C═O)NH₂ end group. Amides are neutral in pH—despite having the —NH, group. Their tendency to attract hydrogen ions is so slight that it can be ignored for most purposes.

Negatively Charged End Groups
Hydroxyl (COH)
Carboxyl (COOH)

Positively Charged End Groups:
Quaternary amine (fatty amine), which has an NCH₃ end group or a N(CH₂)ₙCH₃ repeating group

Not all of these are truly non-reactive, as hydroxyl groups can support hydrogen bonding, carboxyl end groups will react with amines, and amide end groups will bind with carboxyls. However, by making the hydrophilic spacers with shorter length moiety spacer arms than the reactive silanes the biomaterial will not have easy physical access to establishing these chemical reactions.

Hydrophobic spacers are non-reactive functional silane groups that exhibit hydrophobic behavior. These functional end groups include the following:
Vinyl
Mercaptan
Fluorocarbon
Silicon

These materials enable the user to push the surface wettability lower, more hydrophobic, while keeping the reactive silanes spaced sufficiently.

Bonding Chemistry of Amino-Silanes to Amine & Carboxyl Moieties on Biomaterials

Amine to Amine, Hydrogen Sharing

This topology uses hydrogen links. Both are electro-negative nodes. Hydrogen bonds can form between the lone pair on the very electronegative nitrogen atom and the slightly positive hydrogen atom in another molecule.

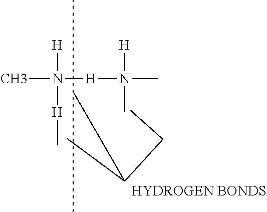

Amine to Carboxyl

This forms an Amide bond (peptide bond).

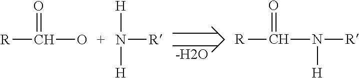

Consider the case when the acrylic acid hydrogen has been exchanged for a Na or K salt atom. The reactions would become:

(ROONa+H₂NR′) in H₂O>>RONHR′—NaOH

Or

(ROOK+H₂NR′) in H₂O>>RONHR′—KOH

In both cases the pH of the water would become greater than seven (>7) because of the base formation. It is important to note that a —COOH group and an —NH₂ group will form a Zwitterion and produce a stronger ionic bonding instead of a hydrogen bond.

Storage related reactions can occur between free amines and moist air to form carbamates. This directly relates to the stability of the amine based coated slides and necessitates their storage in dry containers for optimal performance. The non-reversible carbamate reaction takes place in three steps:
1. Water+Carbon dioxide gas>>Carbonic acid (H₂CO₃)
2. Carbonic acid reacts with amines>>Carbamic acid+water (—NHCOOH+H₂O)
3. Carbamtic acid reacts with amines>>Carbamate (—NH₃OCONH—)

This aging behavior also impacts the storage of protein printed slides and would necessitate sealed packaging of the slides with a desiccant material and/or back filled with nitrogen gas. Alternatively, the reactive amine moieties on the adhesive coating can be covered with a temporary water dissolvable coating that functions as a shield. The shield may or may not contain sacrificial reaction sites. As soon as the slide is put into the water bath to pick up the tissue sample, this shield coating would be set free.

Bonding Chemistry of Epoxide-Silanes to Amine Moieties on Biomaterials

The epoxide to amine bond is non-reversible. While being highly desirable in behavior the epoxide-amine reaction does require the application of heat or time to be effective. Two versions of the epoxide end groups are usable: terminal and meso. Both require a ring to open to form the new bonding. It is interesting to note that both carboxyl and amine reactions sites on the biomaterials can be reacted with the epoxide-silane adhesive coating to reach stable bonds. This is substantially different than with the Amino-silane adhesive where the only the amine-carboxyl reaction results in a stable bond.

There are some performance differences between the terminal and meso epoxide end groups that may make one better for tissue vs. protein/peptide attachments. With only a water solution to transfer tissue or protein/peptide slurries, the terminal end groups will provide a higher reaction efficiency vs. the meso epoxide end group. However, the meso epoxide end group offers a stronger bond that will better survive any application of heat used for HIER. With respect to biomaterials applied to glass microscope slides, both are usable.

Assuming for the moment that the density of epoxide sites is higher than whatever amine structure exists on a biomaterial, to obtain the highest efficiency in bonding density, the pH of the solution that contains the biomaterials would need to be at least 9.0. For tissue mounting, this presents no particular constraints, but for protein/peptide deposits this greatly affects the wetting ability of the slurry and thus results in non-uniform shape dots and uneven biomaterial density. However, if a wetting agent is added to the protein slurry, then the pH can be decreased to 6-7 and the wetting performance will remain high, resulting in uniform shape dots and biomaterial density.

Terminal Epoxide Reactions

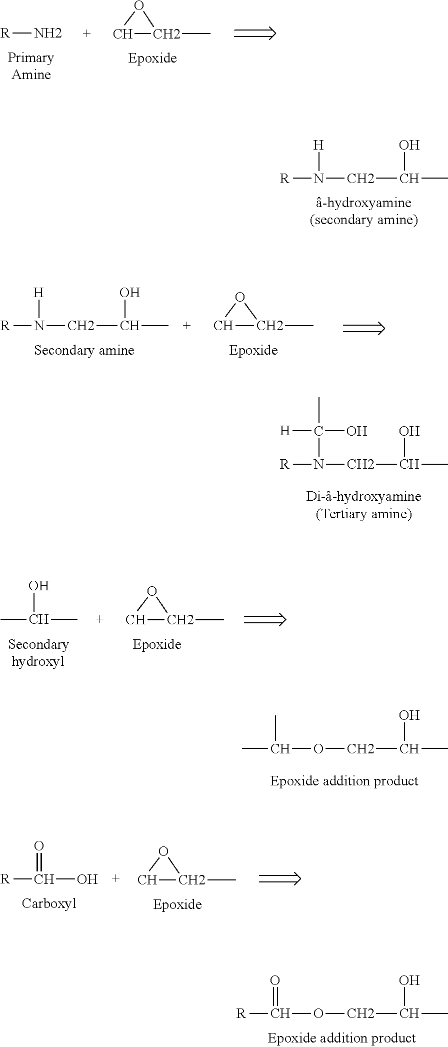

Meso Epoxide Reactions

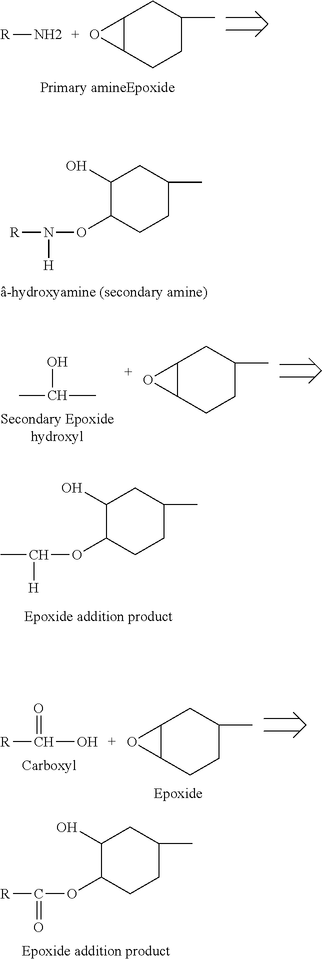

### BRIEF DESCRIPTION OF DRAWINGS

FIG. 1 is a diagrammatic top side view of an adhesive slide according to the invention with a bather ring.

FIG. 2 is a diagrammatic top side view of an adhesive slide according to the invention with multiple bather rings.

FIG. 3 is a diagrammatic top side view of an adhesive slide according to the invention with a grid shaped barrier.

FIG. 4 is a schematic side view of an adhesive slide according to the invention.

FIG. 5 is a schematic side view of the adhesive slide shown in FIG. 4 that is bonded to a polymer.

FIG. 6 is a schematic side view of the adhesive slide shown in FIG. 4 that is bonded to a polymer with cross-linkers, some of which having reactive moieties.

FIG. 7 is a schematic side view of an adhesive slide with reactive silanes of different length.

FIG. 8 is a photograph of a slide according to the prior art that is demonstrating wetting.

### BEST MODE FOR CARRYING OUT INVENTION

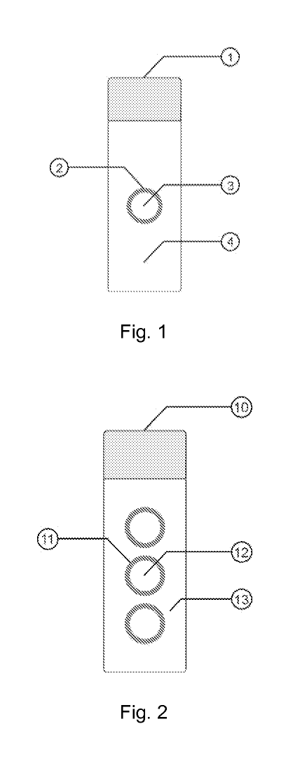

FIG. 1 shows a preferred embodiment of a microscope slide 1. The microscope slide has a coating 2 and 4 of a silane mixture bonded to the microscope slide 1. A hydrophobic barrier ring 3 of epoxide is formed on a top surface of the microscope slide 1. The barrier ring 3 is cured with UV light. The barrier ring 3 holds a sample within the barrier ring 3.

FIG. 2 shows a second embodiment of a microscope slide 10. The microscope slide 10 has a coating 12 and 13 of a silane mixture bonded to the microscope slide 1. Three hydrophobic barrier rings 11 are formed on a top surface of the microscope slide 10.

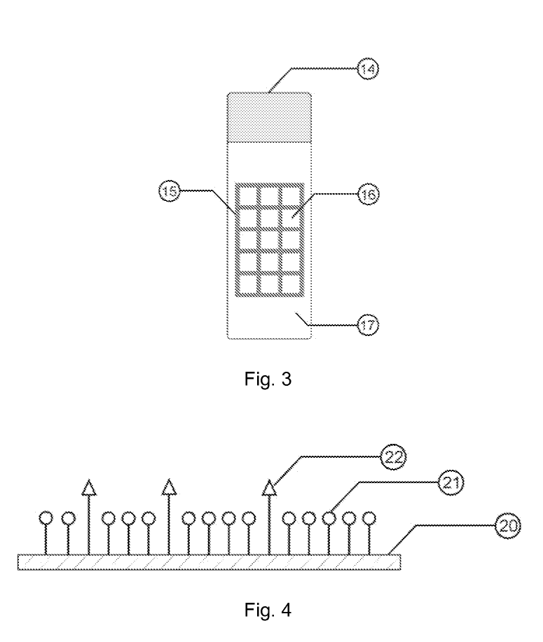

FIG. 3 shows a third embodiment of a microscope slide 14. The microscope slide 14 has a grid 15 of hydrophobic barriers to define an array of sample cells on a top face of the microscope slide 14. The microscope slide 14 has a coating 16 on cells within the grid 15. A silane coating 17 is applied outside of the grid 15.

FIG. 4 shows a coated slide. A microscope slide 20 is provided. Spacer silanes 21 have interposed reactive silanes 22. The spacer silanes 21 can be reactive silanes or non-reactive silanes. The spacer silanes 21 have a short arm length relative to the arm length of the reactive silanes 22. The reactive silanes 22 are spaced apart from each other a greater distance than the height of the reactive silanes 22.

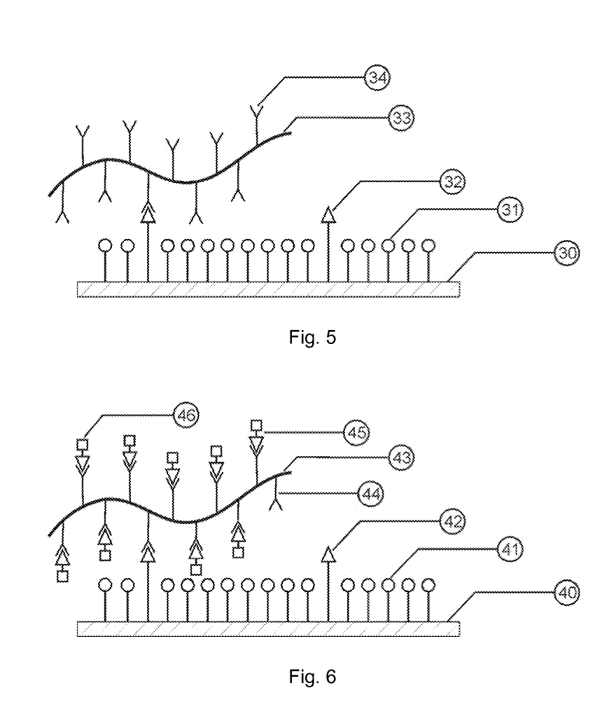

FIG. 5 shows a coated slide with a polymer coating. A microscope slide 30 is the substrate. Spacer silanes 31 are bonded to the microscope slide 30. The spacer silanes 31 can be reactive silanes or non-reactive silanes. Reactive silanes 32 which are taller than the spacer silanes 31 are bonded to the microscope slide 30 and interposed between the spacer silanes 31. A polymer 33 with binding sites 34 is bonded to the reactive terminal sites of the reactive silanes 32.

FIG. 6 shows a coated slide similar to the coated slide in FIG. 5. A microscope slide 40 is the substrate. Spacer silanes 41 with relatively short lengths are bonded to the microscope slide 40. Reactive silanes 42 are bonded to the microscope slide 40. The reactive silanes 42 are taller than the spacer silanes 41. A polymer 43 is shown with binding sites 44 on each monomer in the polymer 43. The binding sites 44 support a covalent reaction with the reactive silanes 42. Hetero or homo bifunctional cross-linkers 45 are bound to the binding sites 44. The cross-linkers 45 include a reactive moiety 46 for binding with biomaterial. The reactive moiety 46 of the cross-linkers 45 can be different than the reactive moiety of the reactive silane 42.

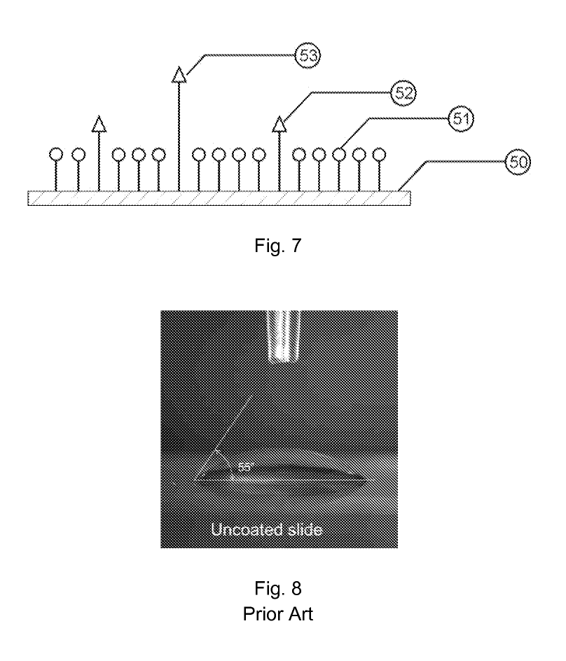

FIG. 7 show a coated slide. A microscope slide 50 is the substrate. Spacer silanes 51 are bonded on a top face of the microscope slide 50. The spacer silanes 51 can be reactive silanes or non-reactive silanes. Shorter reactive silanes 52 are interposed between the spacer silanes 51 and are bonded to the microscope slide 50. Taller reactive silanes are interposed between the spacer silanes 51 and are bonded to the microscope slide 50. The taller reactive silanes 53 are taller than the shorter reactive silanes 52. The taller reactive silanes 53 and shorter reactive silanes 52 are both taller than the spacer silanes 51.

### INDUSTRIAL APPLICABILITY

The coated slide can be used to create reactive control slides for histology and protein assays.

What is claimed is:

1. A coated substrate with an organic reactive surface having a configured wettability, a reactive site density, and a reactive bond type, comprising:
a substrate having a surface;
a first reactive silane applied to said substrate; and
a second component including at least one of a second reactive silane, a non-reactive silane, and a temporary hydrophilic coating.

2. The coated substrate according to claim 1, wherein said substrate is a glass or plastic microscope slide, said glass or plastic microscope slide being covalent bonded to said first reactive silane.

3. The coated substrate according to claim 1, wherein said non-reactive silane is usable as hydrophilic spacer and has end groups, said end group including at least one of a hydroxyl end group and a carboxyl end group.

4. The coated substrate according to claim 1, wherein said non-reactive silane is a non-reactive hydrophobic silane usable as a hydrophobic spacer, said non-reactive hydrophobic silane having a non-organically reactive end group.

5. The coated substrate according to claim 4, wherein said non-organically reactive end group includes at least one of a vinyl end group, a mercaptan end group, and a fluorocarbon end group.

6. The coated substrate according to claim 1, wherein said first reactive silane is a reactive covalent hydrophobic silane for binding organic materials containing amine or carboxyl moieties, said reactive covalent hydrophobic silane including a biomaterial reactive end group.

7. The coated substrate according to claim 6, wherein said biomaterial reactive end group includes at least one of an amine end group, an aldehyde end group, an amide end group, an epoxide end group, and a NHS-ester.

8. The coated substrate according to claim 1, wherein said first reactive silane is a reactive covalent hydrophilic silane for binding to organic materials containing an amine or an amide site, said reactive covalent hydrophilic silane having a carboxyl end group.

9. The coated substrate according to claim 1, wherein said temporary water-soluble hydrophilic coating is used for temporarily masking said first reactive silane, said temporary water-soluble hydrophilic coating being applied over said first-reactive silane.

10. The coated substrate according to claim 7, wherein:
said first reactive silane reacts with airborne organic contaminates; and
said temporary water-soluble hydrophilic coating temporarily prevents said first reactive silane from reacting with the airborne organic contaminates when applied to said first reactive silane.

11. The coated substrate according to claim 1, wherein:
at least one of said first reactive silane and said second reactive silane has a longer spacer arm length and is taller than at least one silane with a shorter spacer arm length selected from the group consisting of said first reactive silane, said second reactive silane, and said nonreactive silane; and
more of said reactive silanes and said nonreactive silanes have said short shorter spacer arm length than have said longer spacer arm length.

12. The coated substrate according to claim 1, further comprising a conformal adhesive coating including a polymer chain with a reactive moiety, said reactive moiety being bondable to a reactive end group of said first reactive silane.

13. The coated substrate according to claim 12, wherein:
said first reactive silane ends with a reactive moiety; and
said polymer chain includes a homobifunctional or heterobifunctional cross-linker having two reactive end groups, a first of said reactive end groups being bonded to said reactive moiety of said first reactive silane, a second of said reactive end groups not being reacted to said first reactive silane in order to change an effective reactive moiety to said second of said reactive end groups of said cross-linker.

14. The coated substrate according to claim 12, wherein:
said first reactive silane is spaced at a given distance from each other on said substrate; and
said polymer chain of said conformal adhesive coating has a length shorter than said given distance between said first reactive silane.

15. The coated substrate according to claim 12, further comprising a cross-linker bonded to unreacted polymers in said polymer chain, said cross-linker having an unbonded function group for bonding to an amine or carboxyl moiety on organic material.

16. The coated substrate according to claim 1, wherein at least one of said first reactive silane and said second component includes hydrophobic silanes and hydrophilic silanes, and a ratio of said hydrophobic silanes to said hydrophilic silanes is manufacturer controlled to create a desired overall wettability.

17. The coated substrate according to claim 1, further comprising an epoxy ring or array of isolated wells disposed on said substrate.

18. The coated substrate according to claim 17, wherein said epoxy ring or array of isolated wells has been UV cured.

19. The coated substrate according to claim 1, wherein said silane mixture includes a silane with an ultraviolet photo-reactive silane end group for promoting adhesion to frozen biological materials.

20. The coated substrate according to claim 1, further comprising a bifunctional crosslinker for extending a length of said first reactive silane and for changing an end reactive moiety of said first reactive silane, said crosslinker being bonded to said first reactive silane and having a different end reactive moiety than said first reactive silane.

21. The coated substrate according to claim 20, wherein said bifunctional crosslinker includes a mixture of bifunctional crosslinkers with different arm lengths.

22. The coated substrate according to claim 1, wherein said first reactive silane has a first reactive moiety and said first reactive silane is disposed at a first location on said substrate; and
a further first reactive silane is applied at a second location on said substrate, said further first reactive silane of said further silane mixture having a second reactive moiety, said second reactive moiety being different than said first reactive moiety.
